(19) United States
(12) Patent Application Publication
(10) Pub. No.: US 2026/0139812 A1
(43) Pub. Date: May 21, 2026

(54) DEHUMIDIFIER OF LAMP FOR VEHICLE AND LAMP INCLUDING THE SAME

(71) Applicants: Hyundai Motor Company, Seoul (KR); Kia Corporation, Seoul (KR); HVS, Suwon-si (KR)

(72) Inventors: Yoonsang Park, Gimcheon-si (KR); Jae Deok Kim, Yongin-si (KR)

(21) Appl. No.: 19/237,212

(22) Filed: Jun. 13, 2025

(30) Foreign Application Priority Data
Nov. 20, 2024 (KR) 10-2024-0166488

(51) Int. Cl. F21S 45/30; F21S 45/10; F21S 45/20; F21S 45/50

(52) U.S. Cl. CPC F21S 45/30; F21S 45/10; F21S 45/20; F21S 45/50

(57) ABSTRACT

A dehumidifier of a lamp for a vehicle, and a lamp including the same, can include a dust cover having at least one communicate hole penetrating between an inside and an outside of the lamp, at least one valve disposed in the at least one communicate hole and configured to selectively open the at least one communicate hole depending on a temperature and a pressure inside the lamp, and a desiccant disposed inside the dust cover and configured to absorb a moisture in the lamp.

### CROSS-REFERENCE TO RELATED APPLICATIONS

This application claims priority to and the benefit of Korean Patent Application No. 10-2024-0166488 filed with the Korean Intellectual Property Office on Nov. 20, 2024, the entire contents of which are incorporated herein by reference.

### TECHNICAL FIELD

The present disclosure relates to a dehumidifier of a lamp for a vehicle.

### BACKGROUND

In general, vehicles are equipped with various types of lamps that perform a lighting function to easily check positions of objects in a vicinity when driving at night and a signal function to inform the running state vehicle to other vehicles and road users.

For example, lamps that perform the lighting functions include head lamps and fog lamps, and lamps that perform the signal functions include turn signal lamps, tail lamps, and brake lamps.

In these lamps for the vehicle, the temperature inside the lamp changes as the light source module inside turns on or off. That is, as the temperature rises when the light source module is turned on, the air inside the lamp expands and the air is discharged to the outside through a vent hole provided in the lamp. Conversely, when the light source module is turned off and the air inside the lamp contracts, an external air flows into the inside of the lamp through the vent hole. Accordingly, when the external air flows into the interior of the lamp, the moisture included in the air also flows into the interior of the lamp.

However, because the lamp is exposed to the outside of the vehicle, if the vehicle is washed after the driving or left in an environment with low external temperature for a long time, the temperature of the lamp may drop below a dew point, which may cause a condensation inside the lamp, resulting in a failure of the light source module of the lamp, or the deterioration of the function of the lamp.

The above information disclosed in this Background section is only for enhancement of understanding of the background of the present disclosure and therefore it may contain information that does not form the prior art that is already publicly known, available, or in use.

### SUMMARY

The present disclosure relates to a dehumidifier of a lamp for a vehicle and more particularly, the present disclosure relates to a dehumidifier for a lamp of a vehicle, which may improve the durability of the lamp by efficiently controlling the humidity inside the lamp for the vehicle, thereby preventing a condensation of the lamp due to a moisture, and preventing a damage to an electronic device due to moisture.

In an embodiment of the present disclosure, a task to be solved can be to provide a dehumidifier of a lamp for a vehicle that discharges an air inside the lamp to an outside when the internal air of the lamp for the vehicle expands, minimizes the inflow of the outside air including a moisture into the inside of the lamp, thereby preventing a condensation from occurring inside the lamp and preventing the electronic device(s) inside the lamp from being damaged due to the moisture.

A dehumidifier of a lamp for a vehicle according to an embodiment of the present disclosure may include: a dust cover having at least one communicate hole penetrating an inside and an outside of the lamp; at least one valve provided in the communicate hole for selectively opening the communicate hole depending on a temperature and a pressure inside the lamp; and a desiccant provided inside the dust cover for absorbing a moisture included in the air.

In some embodiments, the communicate hole may include a first communicate hole and a second communicate hole, and the valve may include a first valve provided in the first communicate hole, and a second valve provided in the second communicate hole.

In some embodiments, the first valve may be a temperature-sensitive valve that selectively opens the first communicate hole depending on the temperature change inside the lamp.

In some embodiments, the first valve may open when the internal temperature of the lamp is above a set, selected, or predetermined temperature, and may be closed when the internal temperature of the lamp is below the set, selected, or predetermined temperature.

In some embodiments, the first valve may be implemented as a bimetal with a first plate and a second plate laminated with different coefficients of thermal expansion.

In some embodiments, one end of the bimetal may be installed and fixed to the dust cover, and the other end of the bimetal may be a free end.

In some embodiments, the second valve may be a pressure-sensitive valve that selectively opens the second communicate hole depending on pressure changes inside the lamp.

In some embodiments, the second valve may open when the internal pressure of the lamp is above a set, selected, or predetermined pressure, and be closed when the internal pressure of the lamp is below the set, selected, or predetermined pressure.

In some embodiments, the second valve may include: a pressure body that is inserted into the second communicate hole and has both ends opened to form a flow path inside; a pressure cap coupled to the end of the pressure body and having at least one air hole formed therein; and a pressure elasticity plate provided in the pressure cap and selectively opening the air hole by the pressure inside the lamp.

In some embodiments, the air hole may be provided in multiple numbers, and a fixing protrusion may be formed protruding from the center of the plurality of air holes toward the first communicate hole, and the pressure elasticity plate may be coupled to the fixing protrusion.

In some embodiments, a supporting boss that extends from the pressure body and supports the pressure elasticity plate may be further included.

In some embodiments, a membrane provided in the first communicate hole of the dust cover and blocking a moisture from flowing into the interior of the lamp may be further included.

In some embodiments, a reservoir cup provided inside the dust cover and receiving the desiccant, and a fixing bracket coupled to the dust cover and supporting the reservoir cup and the desiccant toward the dust cover may be further included.

In some embodiments, the fixing bracket may include: a first fixing protrusion supporting the first valve toward the dust cover; and a second fixing protrusion supporting the second valve toward the dust cover.

A lamp for a vehicle according to an embodiment of the present disclosure may include: a housing in which a light source insertion hole is formed; a lens coupled to the housing; a light source module installed inside the appearance formed by a combination of the housing and the lens; and a dehumidifier coupled to the light source insertion hole of the housing; wherein the dehumidifier may include a dust cover in which a receiving space is formed inside and a first communicate hole and a second communicate hole penetrating the inside and the outside of the lamp are formed; a first valve provided in the first communicate hole that selectively opens the first communicate hole depending on the temperature change inside the lamp; a second valve provided in the second communicate hole that selectively opens the second communicate hole depending on the pressure change inside the lamp; and a desiccant provided inside the dust cover for absorbing a moisture included in the air.

In some embodiments, the first valve may be implemented as a bimetal with a first plate and a second plate laminated with different coefficients of thermal expansion.

In some embodiments, one end of the bimetal may be installed and fixed to the dust cover, and the other end of the bimetal may be a free end.

In some embodiments, a lamp can include: a pressure body inserted into the second communicate hole and having both ends opened to form a flow path inside; a pressure cap coupled to the end of the pressure body and having at least one air hole formed therein; and a pressure elasticity plate provided in the pressure cap for selectively opening the air hole by the pressure inside the lamp.

In some embodiments, the air hole may be provided in multiple numbers, and a fixing protrusion may be formed protruding from the center of the plurality of air holes toward the first communicate hole, and the pressure elasticity plate may be coupled to the fixing protrusion.

A membrane provided in the first communicate hole of the dust cover for blocking a moisture from flowing into the interior of the lamp may be further included.

Using an embodiment of the present disclosure, humid air inside a lamp may be discharged to the outside and/or block the communication between the inside and the outside of the lamp in response to the temperature and pressure changes inside the lamp, thereby preventing the humid outside air from flowing into the inside of the lamp.

Advantages that can be obtained or expected from example embodiments of the present disclosure are directly or suggestively described in the following detailed description. That is, various advantages expected from example embodiments of the present disclosure will be described in the following detailed description.

### BRIEF DESCRIPTION OF THE DRAWINGS

The drawings are provided for reference to explain an illustrative example embodiment of the present disclosure, and the technical spirit of the present disclosure should not be interpreted to be necessarily limited to the accompanying drawings.

FIG. 1 is a cross-sectional view illustrating a configuration a lamp for a vehicle according to an example embodiment of the present disclosure.

FIG. 2 is a top view of a configuration of a dehumidifier according to an example embodiment of the present disclosure.

FIG. 3 is a cross-sectional view illustrating a configuration of a dehumidifier according to an example embodiment of the present disclosure.

FIG. 4 is a bottom view showing a configuration of a dehumidifier according to an example embodiment of the present disclosure.

FIG. 5 is a cross-sectional view of a section A-A′ of FIG. 4.

FIG. 6 and FIG. 7 are views to explain an operation of a first valve, and are cross-sectional views of section B-B′ of FIG. 4.

FIG. 8 and FIG. 9 are views to explain an operation of a second valve, and are cross-sectional views of section C-C′ of FIG. 4.

It can be understood that the above-referenced drawings are not necessarily to scale, and can be presenting a somewhat simplified representation of various features illustrative of some principles of an example embodiment of the present disclosure. The specific design features of an example embodiment of the present disclosure, including, for example, specific dimensions, orientations, locations, and shapes, can be determined in part by a particular intended application and use environment, for example.

### DETAILED DESCRIPTION OF ILLUSTRATIVE EMBODIMENTS

Terminology used herein is for the purpose of describing particular example embodiments, and is not intended to necessarily limit the present disclosure. As used herein, singular forms can be intended to also include a plurality of forms, unless the context clearly indicates otherwise. It can be understood that the terms “comprises” or “have” used in the present specification specify the presence of stated features, numerals, steps, operations, components, parts, or a combination thereof, but does not preclude the presence or addition of one or more other features, numerals, steps, operations, components, parts, or a combination thereof. Also, as used herein, the term “and/or” includes any plurality of combinations of items or any of a plurality of listed items.

The present disclosure will be described more fully hereinafter with reference to the accompanying drawings, in which example embodiments of the disclosure are shown. As those skilled in the art can realize, the described embodiments may be modified in various different ways, all without departing from the spirit or scopes of the present disclosure.

To clearly explain the present disclosure, parts that are not related to the explanation can be omitted. Like reference numerals can designate like elements throughout the specification.

Further, because the sizes and thicknesses of constituent members shown in the accompanying drawings can be arbitrarily given for better understanding and ease of description, the present disclosure is not necessarily limited to the illustrated sizes and thicknesses, and the thicknesses can be shown enlarged to clearly express various parts and regions.

In describing example embodiments of the present specification, when it is determined that a detailed description of the well-known art associated with the present disclosure may obscure the gist of the present disclosure, it can be omitted.

The accompanying drawings are provided to allow example embodiments disclosed in the present specification to be easily understood and are not to be interpreted as necessarily limiting the spirit disclosed in the present disclosure, and it can be understood that the present disclosure can include modifications, equivalents, and substitutions without departing from the scopes and spirit of the present disclosure.

Terms including ordinal numbers such as “first,” “second,” and the like, can be used merely to describe various components, and are not necessarily limiting these components. The terms can be used merely to differentiate one component from other components.

In the description, expressions described in the singular in this specification may be interpreted as the singular or plural unless an explicit expression such as “one” or “single” is used.

Hereinafter, a dehumidifier for a lamp for a vehicle and a lamp including the same according to an embodiment of the present disclosure is described in detail with reference to attached drawings.

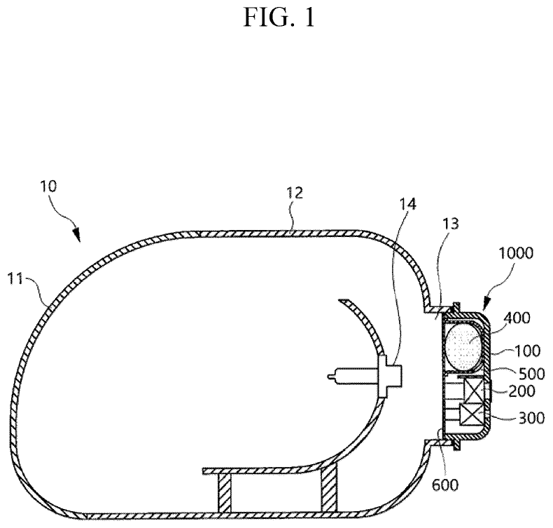

FIG. 1 is a cross-sectional view illustrating a configuration of a lamp for a vehicle according to an example embodiment of the present disclosure.

The dehumidifier of the lamp for the vehicle according to an embodiment of the present disclosure, as shown in FIG. 1, may be installed in a lamp 10 provided in the vehicle.

The lamp 10 for the vehicle may include a lens 11, a housing 12, a light source module 14, and a dehumidifier 1000.

The lens 11 and the housing 12 are combined to form the overall appearance of the lamp 10 for the vehicle, and the light source module 14 may be installed inside the appearance formed by the combination of the lens 11 and the housing 12.

A light source insertion hole 13 into which the light source module 14 may be inserted may be formed in the housing 12, and, if necessary, the light source module 14 may be replaced through the light source insertion hole 13.

The light source module 14 irradiates a light, and the light irradiated from the light source module 14 may be emitted to the outside of the lamp 10 through the lens 11.

A dehumidifier 1000 may be provided in the light source insertion hole 13, and the dehumidifier 1000 may be coupled to the light source insertion hole 13 such that the light source insertion hole 13 is blocked. However, the method of combining the dehumidifier 1000 according to the example embodiment may not be limited thereto.

Next, the dehumidifier of the lamp for the vehicle according to an example embodiment will be described in detail with reference to attached drawings.

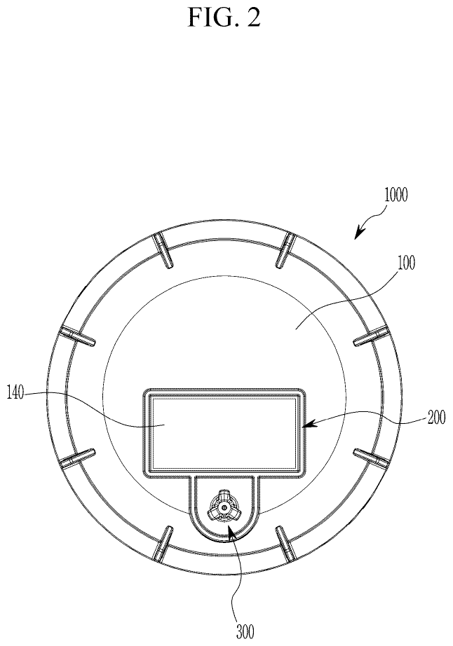

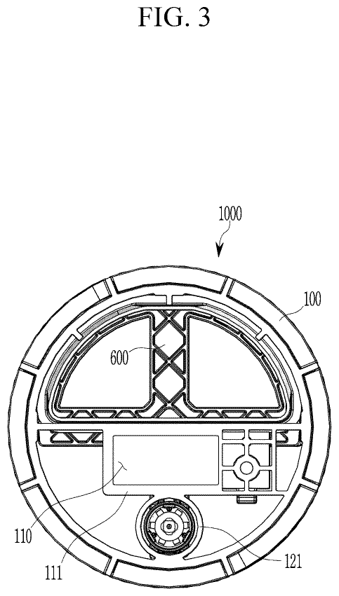

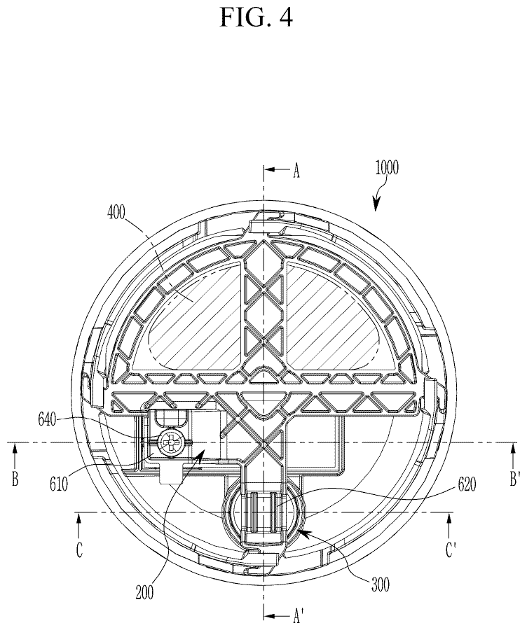

FIG. 2 is a top view of a configuration of a dehumidifier according to an example embodiment of the present disclosure. FIG. 3 is a cross-sectional view illustrating a configuration of a dehumidifier according to an example embodiment of the present disclosure. FIG. 4 is a bottom view showing a configuration of a dehumidifier according to an example embodiment of the present disclosure.

As shown in FIG. 2 to FIG. 5, the dehumidifier 1000 of the lamp for the vehicle may include a dust cover 100 having a receiving space formed inside and at least one communicate hole penetrating the inside and the outside of the lamp, at least one valve provided in the communicate hole of the dust cover 100 for selectively opening the communicate hole depending on a temperature and a pressure, and a desiccant 400 provided inside the dust cover 100 for absorbing a moisture contained in the air.

The dust cover 100 can be formed in a concave cup or a container shape with an opening in the direction toward the housing 12 and the lens 11, and the receiving space may be formed inside. The dust cover 100 may be provided with two communicate holes, and may include a first communicate hole 110 and a second communicate hole 120.

The valves may be respectively provided in the first communicate hole 110 and the second communicate hole 120, and may include a first valve 200 provided in the first communicate hole 110, and a second valve 300 provided in the second communicate hole 120.

The first valve 200 may be a temperature-sensitive valve that selectively opens the first communicate hole 110 depending on the temperature change inside the lamp 10 (e.g., the temperature change of the air inside the housing 12 and the lens 11).

When the first valve 200 opens according to the temperature change inside the lamp 10, the inside and outside of the dust cover 100 may communicate through the first communicate hole 110. Also, when the first valve 200 is blocked due to the temperature change inside the lamp 10, the first communicate hole 110 can be blocked and the communication between the inside and outside of the dust cover 100 may be blocked.

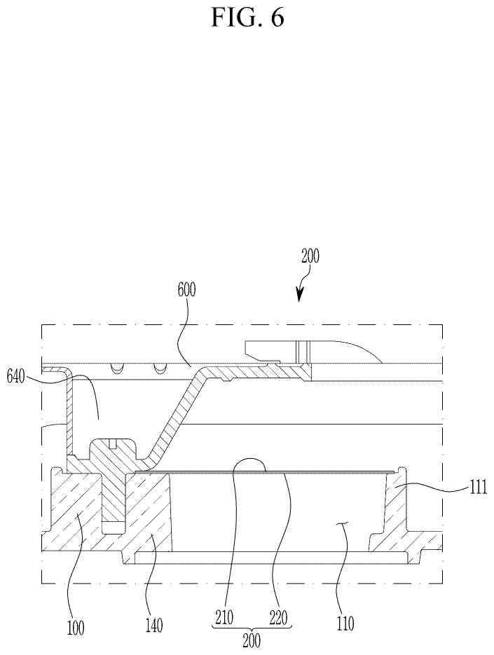

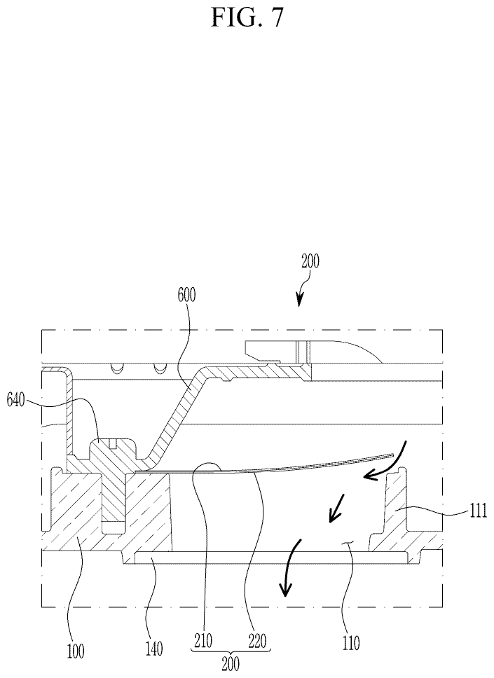

Referring to FIGS. 6 and 7, the first valve 200 may be opened if the internal temperature of the lamp 10 is above a set, selected, or predetermined temperature, and may be closed if the internal temperature of the lamp 10 is below a set, selected, or predetermined temperature. For this purpose, the first valve 200 may be implemented as a bimetal in which the first plate 210 and the second plate 220, which have different coefficients of thermal expansion, are stacked.

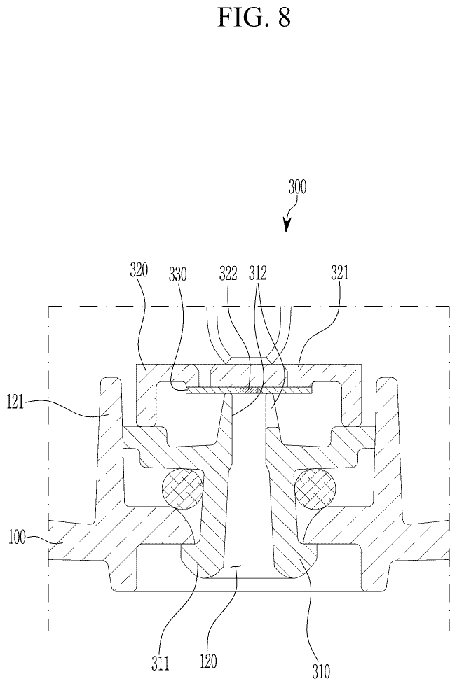

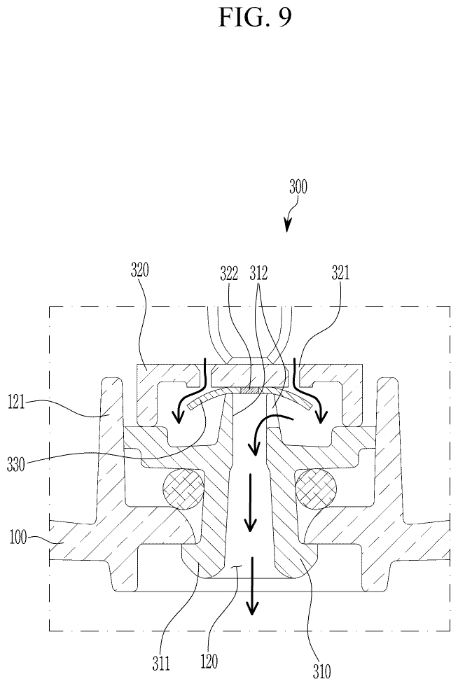

Referring to FIGS. 8 and 9, the second valve 300 may be a pressure-sensitive valve that selectively opens the second communicate hole 120 depending on pressure changes inside the lamp 10 (e.g., the pressure changes in the air inside the housing 12 and the lens 11).

When the second valve 300 opens depending on the pressure change inside the lamp 10, the inside and outside of the dust cover 100 may communicate through the second communicate hole 120. Also, when the second valve 300 is blocked due to the pressure change inside the lamp 10, the second communicate hole 120 can be blocked and the communication between the inside and outside of the dust cover 100 may be blocked.

The second valve 300 may be opened if the internal pressure of lamp 10 is above a set, selected, or predetermined pressure, and may be closed if the internal pressure of lamp 10 is below a set, selected, or predetermined pressure. Alternatively, the second valve 300 may be opened if the difference between the internal pressure of the dust cover 100 and the external pressure is greater than a set, selected, or predetermined pressure, and may be closed if the difference between the internal pressure of the dust cover 100 and the external pressure is less than a set, selected, or predetermined pressure.

In an embodiment, the second valve 300 may be implemented as a pressure-sensitive valve that opens and blocks the second communicate hole 120 through an elastic member that deforms depending on the pressure changes inside and outside the lamp 10. That is, if the pressure difference between the inside and outside of the lamp 10 is greater than or equal to a set, selected, or predetermined pressure, the second communicate hole 120 may be opened by the deformation of the elastic member, and if the pressure difference between the inside and outside of the lamp 10 is less than a set, selected, or predetermined pressure, the second communicate hole 120 may be blocked by the deformation of the elastic member.

The second valve 300 may be implemented as one-directional valve that allows the air inside the lamp (10, or the dust cover 100) to flow only to the outside of the lamp 10. Because the second valve 300 may be implemented as a one-directional valve, the humidity inside the lamp 10 may be efficiently controlled.

The desiccant 400 may be installed inside the dust cover 100 and may absorb the moisture included in the surrounding air.

The desiccant 400, used in the lamp 10 for the vehicle, may absorb the moisture by being solidified through a chemical reaction with the moisture. The desiccant 400 may have the performance absorbing the moisture as well as anti-discharge characteristics to minimize the discharge of the captured moisture.

Hereinafter, the configuration of the first valve 200 and the second valve 300 is described in more detail with reference to attached drawings.

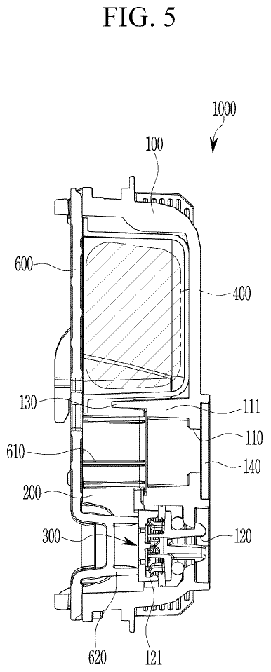

Referring to FIG. 5 to FIG. 9, on the inner surface (e.g., the surface formed in the direction toward the lens 11 and the housing 12 in the dust cover 100) of the dust cover 100, a barrier rib 130 partitioning the internal space, a first circumference wall 111 partitioning the circumference of the first communicate hole 110, and a second circumference wall 121 partitioning the circumference of the second communicate hole 120 may be formed.

The inner space of the dust cover 100 may be partitioned into an upper space and a lower space by the barrier rib 130, and the desiccant 400 may be positioned in the upper space, and the first valve 200 and the second valve 300 may be positioned in the lower space.

The first circumference wall 111 may be formed to protrude from the inner side of the dust cover 100 toward the inner space along the circumference of the first communicate hole 110.

The first circumference wall 111 may be formed in an approximately rectangular shape and may be formed to surround the first communicate hole 110.

A mounting groove may be formed at the end of the first circumference wall 111, and one end of the first valve 200, which is implemented as a bimetal, may be mounted in the mounting groove. The bimetal mounted in the mounting groove may be fixed to the first circumference wall 111 via a fastening member 640 (e.g., a bolt, etc.).

By installing one end of the bimetal fixed to the first circumference wall 111, the other end of the bimetal may be a free end.

The first plate 210 may be arranged to be toward the housing 12 and the lens 11 of the lamp 10, and the second plate 220 may be arranged to face the first plate 210.

The first valve 200, which can be implemented as the bimetal, may be joined by stacking the first plate 210 and the second plate 220, which have different coefficients of thermal expansion. Because the coefficient of thermal expansion of the first plate 210 can be formed to be greater than that of the second plate 220, when the internal temperature of the lamp 10 is lower than a set, selected, or predetermined temperature, the bimetal may adhere to the mounting groove of the first circumference wall 111 and block the first communicate hole 110. Accordingly, the inside and the outside of the lamp 10 are blocked.

Conversely, if the internal temperature of the lamp 10 is higher than a set, selected, or predetermined temperature, the other end of the bimetal bends from the second plate 220 toward the first plate 210 with the fixed end as a reference, and accordingly, the first communicate hole 110 may be opened. Accordingly, the inside and the outside of lamp 10 may be communicate through the first communicate hole 110, and the internal air of the lamp 10 may be discharged to the outside.

The second circumference wall 121 may be formed into a cylinder shape with a hollow interior. The interior diameter of the second circumference wall 121 may be formed to be larger than the diameter of the second communicate hole 120, so that the second circumference wall 121 may be formed to surround the second communicate hole 120. A second valve 300 may be installed by being inserted inside the second circumference wall 121.

The second valve 300 implemented as a pressure-sensitive valve may include a pressure body 310, a pressure cap 320, and a pressure elasticity plate 330.

The second communicate hole 120 may be inserted into the pressure body 310, and both ends may be opened so that a flow path may be formed inside. A pressure hook 311 may be formed at one end of the pressure body 310, and the exterior diameter of one end of the pressure body 310 may be formed to a size corresponding to the diameter of the second communicate hole 120. One end of the pressure body 310 may be inserted into the second communicate hole 120, and the pressure hook 311 may be inserted into the second communicate hole 120 by an elasticity deformation, and then the pressure hook 311 may be restored, and one end of the pressure body 310 may be fixed to the dust cover 100 so that it may be installed.

The pressure cap 320 may be coupled to the other end of the pressure body 310. At least one air hole 321 may be formed in the pressure cap 320. A plurality of air holes 321 may be formed, and the plurality of air holes 321 may be formed along a circumferential direction with the center of the pressure cap 320 as a reference. At the center of the pressure cap 320 (or, at the center of a plurality of air holes 321), a fixing protrusion 322 may be formed by protruding toward the first communicate hole 110.

The pressure elasticity plate 330 may be formed into a circular plate. The pressure elasticity plate 330 may be formed of a metal plate of an elasticity material. The pressure elasticity plate 330 may be provided on the lower surface of the pressure cap 320 facing the second communicate hole 120, and the pressure elasticity plate 330 may be closely attached to the lower surface of the pressure cap 320. The pressure elasticity plate 330 may selectively open the air hole 321 by the pressure inside the lamp 10. A fixing hole can be formed in the center of the pressure elasticity plate 330, and the fixing hole may be inserted into and joined to the fixing protrusion 322 of the pressure cap 320.

The pressure elasticity plate 330 may be elastically deformed by the pressure difference between the inside and outside of the lamp 10, thereby selectively opening the air hole 321. For example, if the pressure inside the lamp 10 is lower than the pressure outside the lamp 10, the pressure elasticity plate 330 may remain in close contact with the pressure cap 320 and the air hole 321 may be blocked. Accordingly, the inside and outside of lamp 10 may not communicate through the air hole 321. Conversely, if the pressure inside the lamp 10 is greater than the pressure outside the lamp 10, the pressure elasticity plate 330 may be elastically deformed and the air hole 321 may be opened. Accordingly, the inside and outside of the lamp 10 may communicate, and the air inside the lamp 10 may be discharged to the outside of the lamp 10 through the air hole 321.

If necessary, the pressure body 310 may be formed with a plurality of supporting bosses 312 extending toward the pressure elasticity plate 330. The supporting boss 312 may support the pressure elasticity plate 330 so that the central part of the pressure elasticity plate 330 may be supported to be in close contact with the pressure cap 320. The supporting boss 312 may support between the fixing hole of the pressure elasticity plate 330 and the air hole 321.

The dehumidifier of the lamp for the vehicle according to an embodiment of the present disclosure may be provided in the first communicate hole 110 and may include a membrane 140 that blocks a moisture from flowing into the interior of the lamp 10. The membrane 140 may be bonded to the circumference of the first communicate hole 110, and the first communicate hole 110 may be blocked by the membrane 140. The membrane 140 may be formed of a material that does not allow a water to pass through but allows a moisture (an aqueous vapor) to pass through. Accordingly, a water may be prevented from flowing from the outside of the lamp 10 into the inside of the lamp 10, and a moisture inside the lamp 10 may be discharged to the outside of the lamp 10.

Inside the dust cover 100, a reservoir cup 500 for accommodating the desiccant 400 and a fixing bracket 600 for supporting the reservoir cup 500 and the desiccant 400 toward the dust cover 100 may be provided.

The reservoir cup 500 may be formed into a shape of a hollow container. The desiccant 400 may be accommodated inside the reservoir cup 500. The reservoir cup 500 may be positioned on the upper part of the dust cover partitioned by the barrier rib 130.

The fixing bracket 600 may be coupled to the dust cover 100 and may support the reservoir cup 500 and the desiccant 400 toward the dust cover 100. After installing the desiccant 400, the first valve 200, and the second valve 300 on the dust cover 100, the fixing bracket 600 may be attached to the dust cover 100 so that the desiccant 400, the first valve 200, and the second valve 300 may be fixed while being pressurized by the fixing bracket 600.

The fixing bracket 600 may be formed with a first fixing protrusion 610 that supports the first valve 200 toward the dust cover 100, and a second fixing protrusion 620 that supports the second valve 300 toward the dust cover 100.

Hereinafter, the operation of the dehumidifier of the lamp for the vehicle according to an embodiment of the present disclosure is described in detail with reference to attached drawings.

Referring to FIGS. 1, 6 and 7, if the light source module 14 of the lamp 10 turns off, or if the temperature inside lamp 10 drops below a set, selected, or predetermined temperature, the first valve 200 implemented as a heat sensitive valve may block the first communicate hole 110. Accordingly, a moist air outside the lamp 10 is prevented from flowing into the interior of the lamp 10 through the first communicate hole 110 (referring to FIG. 6).

Conversely, if the light source module 14 of the lamp 10 lights up, or the temperature inside the lamp 10 rises above a set, selected, or predetermined temperature, the first valve 200 may open the first communicate hole 110. Accordingly, the moist air inside lamp 10 may be discharged to the outside of the lamp 10 through the first communicate hole 110 (referring to FIG. 7).

In the dehumidifier of the lamp for the vehicle according to an embodiment of the present disclosure, referring to FIG. 8 and FIG. 9, when the internal pressure of the lamp 10 is lower than the external pressure of the lamp 10 by a set, selected, or predetermined pressure, the second valve 300 implemented as a pressure-sensitive valve may block the second communicate hole 120. Accordingly, the moist air outside the lamp 10 is prevented from flowing into the interior of the lamp 10 through the second communicate hole 120 (referring to FIG. 8).

Conversely, if the internal pressure of the lamp 10 is higher than the external pressure of lamp 10 by a set, selected, or predetermined pressure or more, the second valve 300 may open the second communicate hole 120. Accordingly, the moist air inside the lamp 10 may be discharged to the outside of the lamp 10 (referring to FIG. 9).

The desiccant 400 may prevent the condensation from forming inside the lamp 10 even if the temperature outside the lamp 10 drops below a dew point temperature by absorbing the moisture included in the air inside the lamp 10.

The dehumidifier of the lamp for the vehicle according to an embodiment of the present disclosure may discharge the moist air inside the lamp 10 to the outside and/or block the communication between the inside and the outside of the lamp 10 in response to the temperature change and/or the pressure change inside the lamp 10, thereby preventing the moist outside air from flowing into the inside of the lamp 10. Through this, the durability of the lamp 10 may be improved and a function deterioration may be prevented by preventing the condensation from forming inside the lamp 10 in advance.

A number of embodiments have been disclosed herein. It can be understood that various features of the different embodiments can be combined.

While the present disclosure has been described in connection with what is presently considered to be practical example embodiments, it can be understood that the disclosure is not limited to the disclosed embodiments, but, on the contrary, is intended to cover various modifications and equivalent arrangements included within the spirit and scopes of the appended claims.

1. A dehumidifier for a lamp of a vehicle comprising:
a dust cover configured to be coupled to a vehicle lamp housing of the lamp of the vehicle, the dust cover having at least one communicate hole penetrating between an inside and an outside of the lamp;
at least one valve disposed in the at least one communicate hole and configured to selectively open the at least one communicate hole depending on a temperature and a pressure inside the lamp; and
a desiccant disposed inside the dust cover.

2. The dehumidifier of claim 1, wherein the at least one communicate hole comprises a first communicate hole and a second communicate hole, and
wherein the at least one valve comprises a first valve disposed in the first communicate hole, and a second valve disposed in the second communicate hole.

3. The dehumidifier of claim 2, wherein the first valve comprises a temperature-sensitive valve configured to selectively open the first communicate hole depending on a temperature change inside the lamp.

4. The dehumidifier of claim 3, wherein the first valve is configured to open based on the temperature inside the lamp being above a first temperature, and wherein the first valve is configured to be closed based on the temperature inside the lamp being below the first temperature.

5. The dehumidifier of claim 3, wherein the first valve is implemented as a bimetal with a first plate and a second plate laminated together, wherein the first plate and the second plate have different coefficients of thermal expansion.

6. The dehumidifier of claim 5, wherein a first bimetal end of the bimetal is installed and fixed to the dust cover, and wherein a second bimetal end of the bimetal is a free end.

7. The dehumidifier of claim 2, wherein the second valve comprises a pressure-sensitive valve configured to selectively open the second communicate hole depending on pressure changes inside the lamp.

8. The dehumidifier of claim 7, wherein the second valve is configured to open based on the pressure inside the lamp being above a first pressure, and wherein the second valve is configured to be closed based on the pressure inside the lamp being below the first pressure.

9. The dehumidifier of claim 7, wherein the second valve comprises:
a pressure body inserted into the second communicate hole, wherein the pressure body has both ends thereof being opened to provide a flow path inside the pressure body;
a pressure cap coupled to an end of the pressure body and having at least one air hole formed therein; and
a pressure elasticity plate in the pressure cap and configured to selectively open the at least one air hole based on the pressure inside the lamp.

10. The dehumidifier of claim 9, wherein the at least one air hole comprises a plurality of air holes, the dehumidifier further comprising a fixing protrusion protruding from a central location between the air holes toward the first communicate hole, and
wherein the pressure elasticity plate is coupled to the fixing protrusion.

11. The dehumidifier of claim 9, further comprising a supporting boss that extends from the pressure body and supports the pressure elasticity plate.

12. The dehumidifier of claim 2, further comprising a membrane disposed in the first communicate hole of the dust cover and configured to block an outside moisture from flowing into an interior of the lamp.

13. The dehumidifier of claim 2, further comprising:
a reservoir cup provided inside the dust cover and wherein the desiccant is accommodated in the reservoir cup; and
a fixing bracket coupled to the dust cover and supporting the reservoir cup and the desiccant toward the dust cover.

14. The dehumidifier of claim 13, wherein the fixing bracket comprises:
a first fixing protrusion supporting the first valve toward the dust cover; and
a second fixing protrusion supporting the second valve toward the dust cover.

15. A lamp for a vehicle comprising:
a housing having a light source insertion hole therein;
a lens coupled to the housing;
a light source module installed inside an appearance including a combination of the housing and the lens; and
a dehumidifier coupled to the light source insertion hole of the housing;
wherein the dehumidifier comprises:
a dust cover including a receiving space therein, wherein the dust cover has a first communicate hole and a second communicate hole penetrating between an inside and an outside of the lamp,
a first valve disposed in the first communicate hole and configured to selectively open the first communicate hole depending on a temperature change inside the lamp,
a second valve disposed in the second communicate hole and configured to selectively open the second communicate hole depending on a pressure change inside the lamp, and
a desiccant disposed inside the dust cover and configured to absorb moisture included in the lamp.

16. The lamp of claim 15, wherein the first valve is implemented as a bimetal with a first plate and a second plate laminated together, wherein the first plate and the second plate have different coefficients of thermal expansion.

17. The lamp of claim 16, wherein a first bimetal end of the bimetal is installed and fixed to the dust cover, and wherein a second bimetal end of the bimetal is a free end.

18. The lamp of claim 15, further comprising:
a pressure body inserted into the second communicate hole, wherein the pressure body has both ends thereof being opened to provide a flow path inside the pressure body;
a pressure cap coupled to an end of the pressure body and having at least one air hole formed therein; and
a pressure elasticity plate in the pressure cap and configured to selectively open the at least one air hole based on a pressure inside the lamp.

19. The lamp of claim 18, wherein the at least one air hole is provided in multiple numbers, and further comprising a fixing protrusion protruding from a central location between the air holes toward the first communicate hole, and
wherein the pressure elasticity plate is coupled to the fixing protrusion.

20. The lamp of claim 15, further comprising a membrane disposed in the first communicate hole of the dust cover and configured to block an outside moisture from flowing into an interior of the lamp.
